(19) United States
(12) Patent Application Publication
(10) Pub. No.: US 2013/0322601 A1
(43) Pub. Date: Dec. 5, 2013

(54) LOW FOCAL HEIGHT X-RAY GENERATOR SUITABLE FOR INSPECTION OF OBJECTS CLOSE TO GROUND

(71) Applicant: SATPAL SINGH, Potomac, MD (US)

(72) Inventor: SATPAL SINGH, Potomac, MD (US)

(21) Appl. No.: 13/487,226

(22) Filed: Jun. 3, 2012

(51) Int. Cl. H01J 35/16

(52) U.S. Cl. 378/121

(57) ABSTRACT

A low height x-ray generator that emits a radiation beam close to ground has been presented. This is useful for imaging for inspection purposes of objects lying on ground. The generator comprises of a x-ray tube in a horizontal orientation close to the bottom surface of the generator box and is also in close proximity to a side wall which is made slanting. With such an arrangement, the focal point of the x-ray tube is low and it produces a beam that is hugging close to the ground which is desired to image bottom portion of a package lying on the ground.

### BACKGROUND OF THE INVENTION

1. Field of the Invention

This invention describes a x-ray generator useful for inspection of objects lying on ground.

2. Description of the Related Art

x-ray imaging systems are used for inspection of suspicious packets and objects that are often left abandoned or lying on the ground or floor. It is desirable to image such objects without moving them as there can be a motion triggered explosive in them. For such situations, it is desirable to place a x-ray source on the ground with it emitting a beam whose bottom is hugging the ground so that the bottom most portion of the object lying on the ground can be imaged.

The x-ray radiation beam emitted by x-ray tubes used for inspection is usually cone shaped that is often further shaped by collimators. The box within which the x-ray tubes are mounted are usually in the form of a box whose cross sections are shown in FIGS. 1 and 2. A box 60 contains a x-ray tube 50 which has a focal point F from where emits a x-ray beam 51. FIG. 1 shows the x-ray radiation beam emitted in the upwards direction which is clearly not suited for imaging objects lying on ground. FIG. 2 shows a generator emitting radiation in the horizontal direction which is useful for imaging close to ground objects. Sometimes the object to be imaged may be quiet tall and it may not be possible to move the object far away from the source or generator, in such a case it is desired that the radiation beam 51 in FIG. 2 have a wide divergence so that the upper edge 53 of beam 51 is close to vertical. With the configuration of FIG. 2, if the top edge 53 of beam 51 is made vertical it will hit the top surface of box 60 unless the x-ray tube 50 is moved close to the top surface of the box. But that would mean raising the height of the tube 50 which raises the height of focal point F which make the bottom edge 52 of the beam 51 more angled down toward the ground. This however would leave the lower portions, of an object under inspection, that are not overlapped by the shaded area of the beam 51 to be not imaged.

In addition to rectangular type boxes used to house x-ray generators there are some cylindrical housings too. However, in these the x-ray tube is closed to the inside wall of a much larger cylindrical housing it is in. When such a cylindrical housing is turned so that the beam is emitting horizontally or sideways, the focal point of the tube is then at approximately at a height equal to the radius of much larger cylindrical housing of the generator. This again leads to larger height of focal point which makes the bottom edge of beam 51 angled downwards towards the ground rather than horizontal that is desired to image objects close to ground.

There are also available some x-ray tubes with exit window near to one end of the long dimension of the tube, and some other tubes having end windows as in the case of transmissive tubes. Such tubes can be placed vertical with the exit window emitting the x-ray beam at the bottom of the generator. However such tubes tend to be unipolar with lower energies, are lower intensity. Further, the vertical arrangement makes the height of x-ray generator tall which may not be desirable in some applications.

The objects of this invention are therefore to overcome some of the above problems and are listed next.

### OBJECTS OF THE INVENTION

It is, accordingly, an object of the invention to build a x-ray generator that is suitable for imaging objects lying on the ground, specifically a generator that emits a radiation beam that has a wide angle with the lower part of the beam almost horizontal and hugging the ground, and the upper edge of the beam close to vertical.

It is also an object of this invention to use bipolar x-ray tubes with exit windows in the middle of the length dimension of the tube, such tubes are of higher energies than unipolar, can be better cooled with oil and hence can emit more intense beam, work longer durations without getting over heated. It is also an object of this invention to build a x-ray generator of low height that could be slid underneath objects with little height clearance underneath them.

These and other objects will become apparent in the description that follows.

### SUMMARY OF THE INVENTION

A low height x-ray generator that emits a radiation beam close to ground has been presented. This is useful for imaging for inspection purposes of objects lying on ground. The method presented employs a bipolar tube with exit window in the middle of its long dimension. The tube is placed horizontally close to the bottom of the generator box or its housing. Placing it close to the bottom of the box keeps the focal height of the x-ray tube low which makes it possible for the emitted x-ray beam to have a near horizontal edge that is desirable for imaging objects close to ground.

The x-ray tube is also placed in close proximity to a sidewall of the box that is made slanting. This allows the top edge of the emitted x-ray beam to be close to vertical. The combination of placing the x-ray tube near the bottom of the generator box and also in close proximity to a slanted side wall allows for a wide angle beam that is suitable for imaging objects lying on the ground.

There are several embodiments, objects and advantages to this invention that will be apparent to one skilled in the art. The accompanying figures and description herein should be considered illustrative only and not limiting or restricting the scope of invention, the scope being indicated by the claims.

### BRIEF DESCRIPTION OF THE DRAWINGS

FIG. 1 (prior art) shows the simplified view of a conventional x-ray generator with the beam pointing upwards.

FIG. 2 (prior art) shows the simplified view of a conventional x-ray generator with the beam pointing sideways or horizontally.

FIG. 3A shows a 3D perspective of the generator box according to one embodiment of this invention.

FIG. 3B shows the top view of the box shown in FIG. 3A.

FIG. 4 shows the cross sectional view of the box at dashed line 4-4 in FIG. 3B

FIG. 5 shows a cross sectional view of an alternate embodiment of this invention.

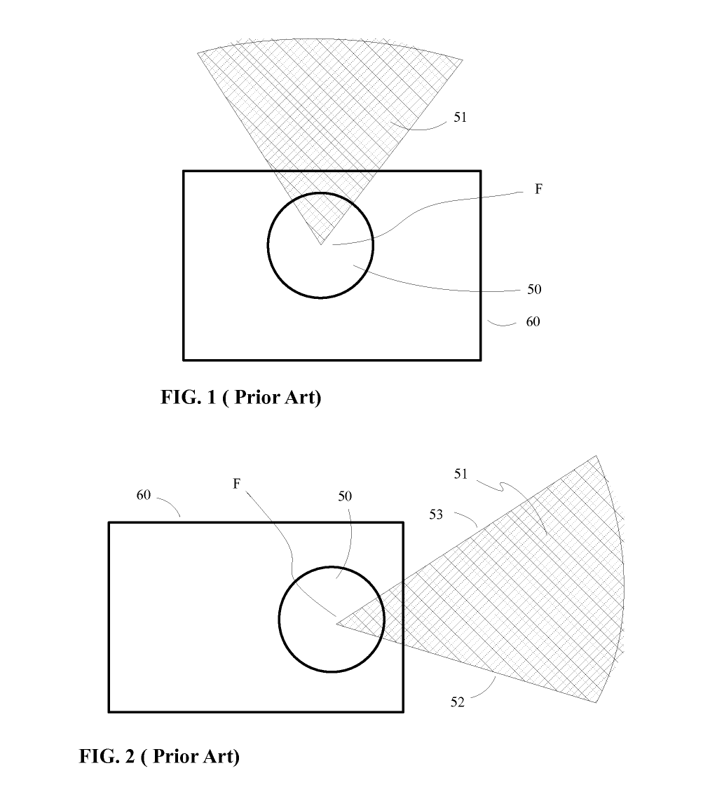

### DETAILED DESCRIPTION OF THE PREFERRED EMBODIMENTS

In describing the preferred embodiment and its alternatives, specific terminology will be used for the sake of clarity. However, the invention is not limited to the specific terms so used, and it should be understood that each specific term includes all its technical equivalents which operate in a similar manner to accomplish similar purpose.

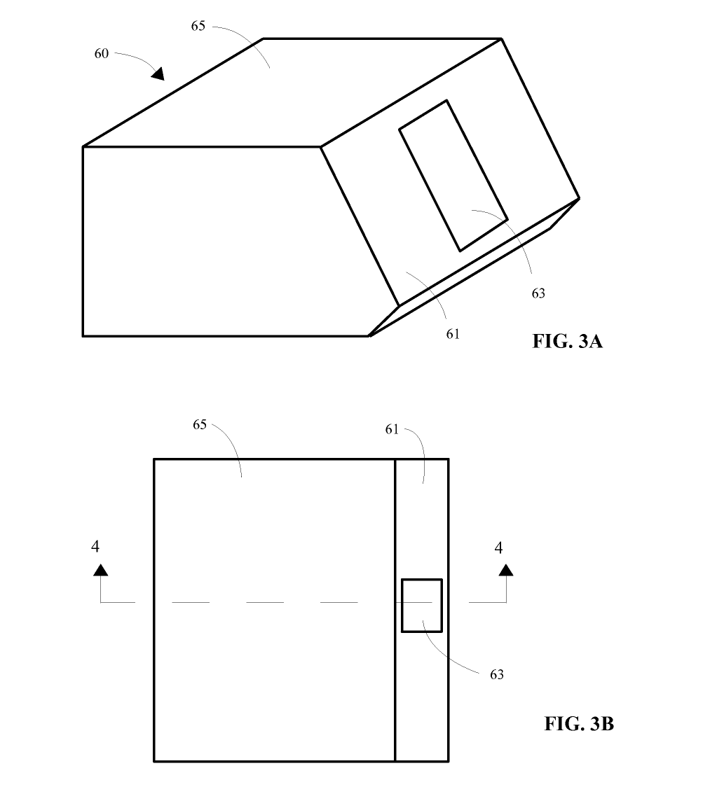

A simplified sketch of a 3D perspective of the generator box according to a preferred embodiment of the invention is shown in FIG. 3A. As shown, the box 60 has a top surface or a top part 65, a side wall or a side part or a slant part 61 that is slanted rather than vertical. The side wall 61 also has a window 63 which is usually made of thin and low density material through which radiation or x-ray beam can easily come out from inside the box.

FIG. 3B shows the top view of the generator box shown in FIG. 3A. Shown is a dashed line 4-4 through which a cross section is taken and the cross section shown in FIG. 4. As shown in FIG. 4, a x-ray tube 50 is placed inside a box or an enclosure 60 that comprises of at least a bottom part 62, top part 65 and a slant part 61 that is positioned between the top part 65 and the bottom part 62. The x-ray tube 50 is positioned close to the bottom surface or the bottom part 62 so that the height of the focal point F of the tube 50 is close to ground. This makes it possible for the lower edge 52 of the beam 51 to be as horizontal as possible. The tube 50 is also in close proximity to the side wall 61 that is made slanting to the vertical. This makes the upper edge 53 of beam 51 to be close to vertical.

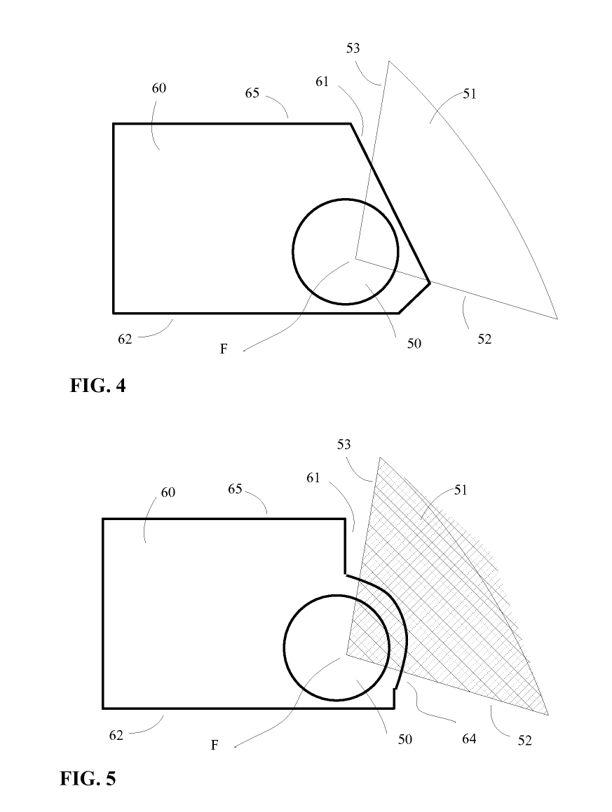

An alternative embodiment of the invention is shown in FIG. 5. As shown, the side wall 61 has at least a curved surface or a curved part 64 in close proximity to the tube 50.

There are several embodiments possible as would be apparent to a person skilled in the art.

The foregoing description of the invention and its embodiments should be considered as illustrative only of the concept and principles of the invention. The invention may be configured in a variety of ways, shapes and sizes and is not limited to the description above. Numerous applications of the present invention will readily occur to those skilled in the art. Therefore, it is desired that the scope of the present invention not be limited by the description above but by the claims presented herein.

The invention claimed is:

1. A x-ray generator comprising of:
an enclosure around a x-ray tube;
said enclosure comprising of at least a top part, a bottom part and a slant part;
said slant part positioned between said top part and said bottom part;
said slant part oriented at a slant angle relative to the vertical;
said x-ray tube seated between said top part and said bottom part; and
said slant part being in close proximity to said x-ray tube.

2. A device of claim 1 wherein:
said slant part further comprises of a curved part.

3. A device of claim 1 wherein said bottom part is flat.

4. A device of claim 2 wherein said bottom part is flat.
